(19) United States
(12) Patent Application Publication
(10) Pub. No.: US 2002/0059510 A1
(43) Pub. Date: May 16, 2002

(54) Data processing system and control method

(76) Inventor: Mitsumasa Yoshimura, Tokyo (JP)

Correspondence Address: William C. Rowland, BURNS, DOANE, SWECKER & MATHIS, L.L.P., P.O. Box 1404, Alexandria, VA, 22313-1404, US

(21) Appl. No.: 09/985,087

(22) Filed: Nov. 1, 2001

(30) Foreign Application Priority Data
Nov. 14, 2000 (JP) 2000-347158

(51) Int. Cl. H04L 1/22

(52) U.S. Cl. 712/34

(57) ABSTRACT

A data processing system of this invention includes at least one special purpose data processing unit having a data path portion for executing specific data process by a special purpose instruction and a general purpose data processing unit for executing processes by general purpose instructions. The data path portion of the special purpose data processing unit includes a plurality of registers, a processing part for performing an operation related to data stored in the registers and a register control part for selecting and performing input and/or output of data with respect to the registers from the general purpose data processing unit. Thus, function unit in a program, such as loop sentence can be compressed into one instruction and any conditions referred in the function unit can be flexibly set and changed.

### CROSS-REFERENCE TO RELATED APPLICATION

The present application claims priority of Japanese Patent Application No. 2000-347158, filed in Japan on Nov. 14, 2000, the entire contents of which are hereby incorporated herein by reference.

### BACKGROUND OF THE INVENTION

1. Technical Field

The invention relates to a data processing system having a special purpose data processing unit having a data path that allows processing by hardware.

2. Description of the Related Art

The pursuit for larger-scales and finer-constructions of LSI has continued for several decades. Lately, system with remarkably great functions is realized on silicon as system LSIs. With such a background, there is a growing demand, aside from high-speed and high-performance general purpose LSIs as represented by Pentium LSI of Intel, for special purpose system LSIs that delivers maximum performance in a specific purpose and/or has better cost performance according to better solutions in the field of a specific application than the general purpose LSI. This demand is particularly remarkable in the field of home information equipment applications represented by digital TVs and the field of communication network applications, including LSIs with low-power consumption requirements as in cellular phones, LSIs suitable for real-time responsiveness and data or packet transfer, LSIs suitable for image compression and decompression for the purpose of transfer of image data, etc.

With this demand, for supplying the special purpose system LSI, a processor is individually developed and produced. If a large-scale dedicated system LSI is requested, the functions to be realized in that system LSI are specified by a high-level language such as the C language, the Java (trade mark) language, in some format. Therefore, the processor shall be developed under the developing system and/or environment having a compiler capable of executing the high-level language. The processor individually developed can be equipped with special purpose instructions and with a special or dedicated purpose circuit for performing special operation described in the high-level language, therefore the special purpose system LSI will be provide with excellent cost performance. For example, Xtensa processor of Tensilica Inc. and VUPU processor of Pacific Design Inc. are processors that can be equipped with special purpose instructions and customized.

As for processes consisting mainly of operations such as product sum and/or coordinate transformation, consume a number of clocks in a general purpose process. Also, contents or purposes of operations to be performed in such processes vary in accordance with the applied field. Therefore, such operations are likely to be performed by the dedicated or special purpose data processing circuit individually developed using the special purpose instruction. Thus, programs with special purpose instructions for executing processes as mentioned above are required.

It is always demanded to improve the efficiency of the execution of the process in a system LSI provided according to the specifications. Corresponding to that demand, the above mentioned data processing apparatuses or systems equipped with the special purpose data processing circuits have been developed, and system LSIs using that architecture enables high processing speed, economical and excellent in real-time processing performance required in the fields of network processing, communication processing, image processing, etc. However, there is still a demand for a system LSI not only with a higher performance in executing but also with a higher efficiency of developing performance.

Accordingly, it is an object of the invention to provide a system LSI capable of more efficiently execute processes (specifications) required in various application fields, and a efficient developing method of that system LSI.

### OBJECTS AND SUMMARY

In the present invention, for further improving an efficiency of executing the processes in a system LSI, some units of routine or function that are required or defined in a program given as the specification are realized by hardware and processed in a special purpose data processing circuit or circuits. The present invention can provide the system LSI having a better performance than the one mere attempt to increase speed through a limited technique in which the specific data processing circuit is used to execute only a specific operation, such as retrieval of bit data or the like. Present invention becomes possible to develop a program that has more effective special purpose instructions that manipulate a large-scale process. By the present invention, the development and the design of the high-speed processing system LSI becomes more flexibly and more efficiently.

The special purpose instruction proposed in this invention executes not only a mere special operation, but also a functional unit or block appears in the program including a subroutine and a program facility. It is an object of the invention to greatly improve the processing efficiency by converting the function unit into a special purpose instruction.

Of the processors that can be equipped with above-described customizable special purpose instructions, Xtensa processor of Tensilica LTD. finds it difficult to execute a large-scale instruction such as the program facility by a single instruction. In this processor, the special purpose instruction is realized by a technique in which some of the RISC processor instructions are rewritten into user-defined instructions. Therefore, this processor is essentially unsuitable for conversion of the program function into the single instruction.

In contrast, situation is different to some extent for VUPU processor of Pacific Design INC. For example, in the art disclosed in Japanese Patent Application Laid-Open No. 2000-207202, the VU portion that is a special purpose data processing unit is capable of operating in multi-cycles, and is capable of executing a large-scale process by the special purpose instruction, while the PU portion corresponding to a RISC processor. Therefore, the VU portion executes not only a special search process, such as start code detection or the like, but also the program function by the single instruction in accordance with the present invention.

Therefore, the present invention proposes a technique for developing a data processing system including a data processing apparatus and a system LSI or the like, in which a specific program function in a program can be executed by a special purpose data processing unit, in the following steps:

1. An original program for executing processes is prepared based on a specification.

2. A specific function unit that is desirable executed by a data path portion for a specific data processing is extracted from the original program.

3. The data processing system having a special purpose data processing unit that has the data path portion for the specific data processing, and a general purpose data processing unit is generated.

4. A program for controlling the data processing system is generated by substituting the original program with a special purpose instruction to the special purpose data processing unit and general purpose instructions to the general purpose data processing unit.

In the data processing apparatus developed according to these steps, the function unit such as a specific program function or a specific routine of the original program according to the required specifications described in the high-level language is turned into the special purpose instruction. The function unit is executed by hardware of the data path portion in the special purpose data processing unit. Therefore, it becomes possible to provide a special purpose processor with very high performance for executing the processes specified.

By the data processing system of this invention, the process of the specific function unit appearing in the program is flexibly and efficiently executed by the special purpose data processing unit that performs hardware operation processor. In order to provide an economical system LSI using the data processing system, it is desirable that the program uses the function of the special purpose data processing unit more efficiently and more frequently. That is, it is desirable that

special purpose instructions to the special purpose data processing unit can be used in the program as frequently as possible.

Therefore, the data processing apparatus in accordance with the invention comprising: the special purpose data processing unit or units having the data path portion for executing specific data process by the special purpose instruction; the general purpose data processing unit for executing processes by the general purpose instructions; and an instruction issue unit for issuing instructions to the special purpose data processing unit and the general purpose data processing unit based on a program that has the special purpose instruction and the general purpose instruction. The data path portion of the special purpose data processing unit includes a plurality of registers; at least one processing part for performing at least one operation related to data stored in at least one of the registers; and a register control part for selecting the registers and performing input and/or output of data with respect to the registers from the general purpose data processing unit.

A control method of the data processing system in accordance with the invention is characterized by comprising a register control step of selecting and performing input and/or output of data with respect to the registers from the general purpose data processing unit.

The special purpose data processing unit of the data processing system of the invention comprises interface registers accessible by the general purpose data processing unit owing to the register control part. The data path portion is capable of performing an operation or operations related to data stored in at least one of the interface registers. The operation includes not only the operation of data stored in the interface registers but also the operation of data to be stored and the like, namely operation of referring to data stored in some interface registers, operation using the data as input data and operation outputting the data as a result. In this data processing system, data stored in the interface registers can be controlled by the program using the general purpose data processing unit.

Therefore, in the control program for the data processing system, it is possible to flexibly utilize the function provided by the special purpose data processing unit. That is, by manipulating data related to the specific function units included in the original program by a register input-output instruction, which is supplied as the general purpose instructions to select an interface register and to input and/or output data with respect to the interface register, the contents of process executed by the special purpose instruction vary. For example, an initial value and a terminal condition (value) of the function unit (program facility) executed by the special purpose data processing unit can be controlled on a program basis via the general purpose data processing unit. If the process relating to the function unit supplied by the special purpose data processing unit appears in the original program, the special purpose data processing unit is used in various cases and conditions. Therefore, the utilization of the special purpose data processing unit is improved, and makes it possible to providing the data processing system being economical and having high processing efficiency and high execution speed.

Accordingly, the program for controlling the data processing apparatus of the invention comprises the special purpose instruction and the general purpose instructions that include the register input-output instruction to select the interface register and to input and output data with respect to the interface register. The program of the invention can be provided by recording it in an appropriate recording medium readable by a computer or a system LSI, such as a RAM, a ROM, etc.

The data processing system may have the register control part comprising a register data bus for exchanging data between the interface registers and the general purpose data processing unit; and a decoder for identifying one of the interface registers based on a designation from the general purpose data processing unit. By the register control part, a subject interface register becomes accessible by the general purpose data processing among the registers or register group in the data path portion, and data can be inputted or outputted with respect to the selected interface register from the general purpose data processing unit. Therefore, the register control step of the control method of this invention preferably has a step of selecting one of the interface registers from the general purpose data processing unit by the decoder and a step of inputting or outputting data with respect to the selected interface register via the register data bus.

One of the effective usages of the interface registers is to set a terminal condition. In this case, One of the processing parts is a terminal condition determining part having a function that compares the terminal condition stored in one of the interface registers with an operation result stored in one of the registers and outputs a factor for terminating the process of the special purpose data processing unit. Therefore, by the register input-output instruction of the general purpose instructions, the terminal condition for the special purpose instruction is set in the special purpose data processing unit.

Another one of effective usages of the interface registers is debugging. In this case, an operation result is stored in one of the interface registers. Data stored in that interface register is monitored by the program via the general purpose data processing unit. Therefore, by the register input-output instruction of the general purpose instructions, the state of processing of the data path portion is monitored.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic diagram of a data processing system (system LSI) equipped with a PU and a VU in accordance with the invention.

FIG. 2 is a block diagram schematically illustrating a construction of the VU.

FIG. 3 is a flowchart schematically illustrating a process of developing a data processing system in accordance with the invention.

FIG. 4 is a flowchart schematically illustrating a Mandelbrot calculation process.

FIG. 5 shows a program describes the process illustrated in FIG. 4 in a C language.

FIG. 6 is a diagram illustrating a state where a function to be processed in the VU is extracted from the program shown in FIG. 5.

FIG. 7 is a diagram schematically illustrating a construction of a data path portion that processes the function extracted in FIG. 6.

FIG. 8 shows control steps of the data path portion illustrated in FIG. 7.

FIG. 9 is a diagram showing a control program obtained by substituting the program shown in FIG. 5 with P instructions and V instructions.

### DESCRIPTION OF THE PREFERRED EMBODIMENTS

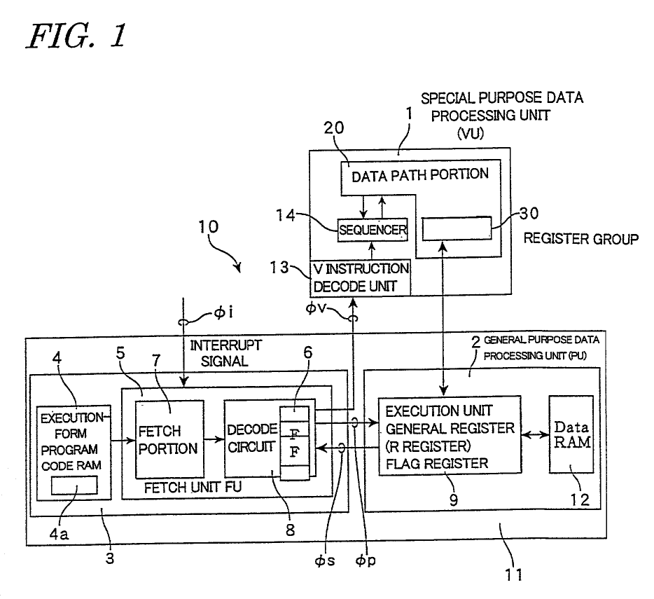

Preferred embodiments of the invention will be described hereinafter with reference to the accompanying drawings. FIG. 1 shows a data processing system 10, which is sometime referred as a data processing apparatus, a processor, or a system LSI, comprising a special purpose data processing unit, (special purpose instruction execution unit, hereinafter referred to as “VU”) 1 specialized for a specific process, and a general purpose data processing unit (general purpose instruction executing unit or process unit, hereinafter referred to as “PU”) 2. The data processing system 10 is a programmable processor or a programmable system LSI. This LSI 10 has an instruction issue unit 3 for providing control signals to be decoded by the VU 1 and PU 2.

The instruction issue unit 3 (dispatch unit, hereinafter referred to as “DU”) 3 has a code RAM 4 containing an execution-formed control program (program code, micro-program code) 4a, and a fetch unit 5 that fetches instructions from the code RAM 4. The fetch unit 5 includes a fetch portion 7 that fetches an instruction or instructions from a predetermined address of the code RAM 4 according to the previously fetched instruction, the state of a state register 6, an interrupt signal fi, etc. The fetch unit 5 further includes a decode circuit 8 that decodes fetched special purpose instructions and/or a fetched general purpose instruction (universal instruction) for supplying the special purpose instruction fv, which is the same or a decoded control signal of the fetched special purpose instruction, and the general purpose instruction fp, which is the same or a decoded control signal of the fetched general purpose instruction, to the VU 1 and PU 2 respectively. Furthermore, the PU 2 sends a status signal indicating the state of execution (exec unit status signal) fs back, so that the status of the PU 2 and the VU 1 is reflected in the state register 6.

The PU 2 includes an execution unit (EU) 9 that is high versatility execution unit and has general-purpose registers, flag registers, arithmetic units (ALU), etc. EU 9 further includes a data RAM 12 that serves as a temporary storage area of the EU 9. A block or section having the instruction issue unit DU 3 and the general purpose data processing unit PU 2 contains the code RAM 4, the FU 5 and the EU 9, which is substantially the same of an ordinal process unit. Therefore, the block having the DU 3 and PU 2 may be referred as processor unit 11 and the data processing system 10 may also be constructed or designed by the processor unit 11 and the VU 1 controlled through the processor unit 11.

The special purpose data processing unit VU 1, which executes special purpose instruction fv from the DU 3 or the processor unit 11, includes a unit 13 for decoding whether the instruction is the V instruction fv. The decoding unit 13 also judges, when the data processing system 10 has a plurality of the VUs 1, whether the instruction is the instruction to the VU 1 itself. The VU 1 further includes a sequencer (FSM (finite state machine)) 14 for outputting a control signal so as to perform specific data processes by hardware, and a data path portion 20 designed so as to perform the specific data processes in accordance with the control signal from the sequencer 14. The data path portion 20 is designed so as to utilize a register group 30 that includes a plurality of interface registers accessible from the PU 2. Therefore, via the interface registers of the register group 30, PU 2 can control the data needed for the processes in the data path portion 20, and referred to the internal state of the VU 1. A result of the processes in the data path portion 20 is supplied to the PU 2 for performing another processes in the PU 2 using the result.

In the LSI 10 shown in FIG. 1, the code RAM 4 stores a program that includes general purpose instructions (P instructions) and special purpose instructions (V instructions), which are fetched by the fetch unit 5. The fetched instruction is outputted from the DU 3 as a decoded control signal fp or fv. The VU 1 discriminates the decoded control signal fv of the V instruction for the VU 1 itself from the control signals fp and fv and starts the process. For the PU 2, only the control signals fp of the decoding P instructions are supplied. DU 3 issues a control signal indicating op that skips the process of the PU 2 instead of the instructions decoded the V instructions that cannot be executed by the PU 2. Since the nop instruction is issued instead of the control signal obtained by decoding V instructions, the PU 2 does not need to cope with the V instructions or the control signal obtained by decoding the V instructions.

That is, the VU 1 usually being changed or specialized depending on applications. Therefore, in many cases, the special purpose instructions for commands to the VU 1 vary depending on applications. The VU 1 consists of a special purpose circuit specialized for the application. It is easy to design the VU 1 so as to interpret each control signal corresponding to varied V instructions. On the other hand, since the nop instruction is issued corresponding to the all V instructions, the PU 2 does not need to cope with the V instructions varied and specialized for each VU 1. The PU 2 needs only to have functions for interpreting and executing basic instructions prepared as the general purpose instructions. Therefore, the PU 2 can coexist with the VU 1 adapted to the application of a varying kind, without sacrificing versatility and uniformity, and PU 2 can control and perform processes using results of operations of the VU 1 varied according to the application.

The data processing apparatus 10 shown in FIG. 1 may have the VU 1 capable of realizing a process that needs a special operation, such as a real-time response, and the versatile PU 2. Therefore, without sacrificing the real time responsiveness, the data processing apparatus 10 makes it possible to reduce the period of design and development and flexibly cope with changes and corrections may occurred at later stages. The number of VUs 1 is not limited to one. It is possible to provide a plurality of VUs 1 and include a plurality of special purpose instructions for operating the VUs 1 into program codes so as to perform special processes required by applications. Furthermore, the VU 1 in this embodiment is designed not only for special operation but is also designed so that a specific program function or facility in the program can be realized by the special circuit for performing efficiently the program. Thus, the VU 1 is the architecture that is able to apply wider for performing the application in an optimizing way.

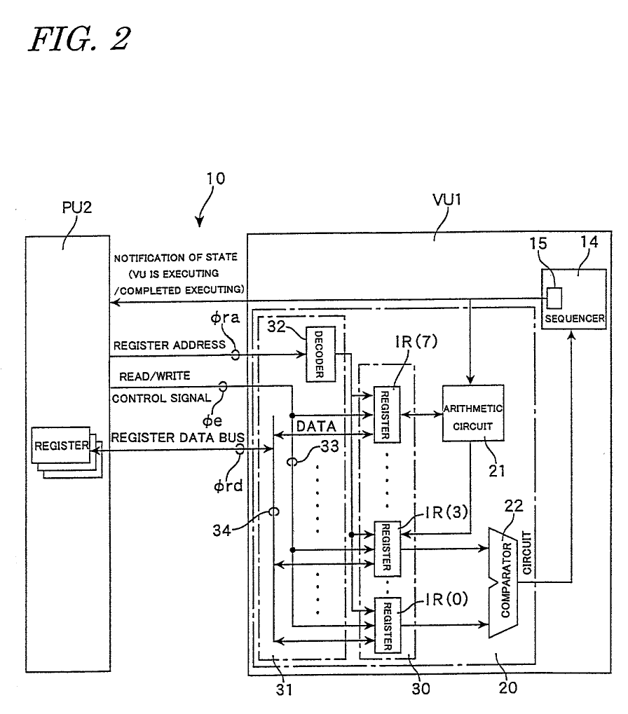

FIG. 2 schematically shows a construction of the VU 1 adopted in the data processing system 10 in this embodiment. The data path portion 20 of the VU 1 has a register group 30 that includes a plurality of interface registers IR (i) hereinafter, IR(i), where i is an appropriate integer) accessible from the PU 2. Also, processing parts or circuits such as an arithmetic circuit 21 and a comparator circuit 22 and the like that forming the data path portion 20 can refer to the data stored in the registers IR(i) and input and output with respect to the registers IR(i), if required.

Furthermore, the data path portion 20 has a register control part or circuit 31 capable of selecting any registers IR(i) and performing input and output of the data with respect to the selected IR(i) from the side of the PU 2. The register control circuit 31 in this embodiment includes a decoder 32 that decodes a register address signal fra supplied from the PU 2 for identifying one of the interface registers and enables the corresponding register IR(i), control signal lines 33 that supplies a read or write control signal fe to the registers IR(i), and a data bus (register data bus) 34 for inputting and outputting register data frd with respect to the IR(i) from the PU 2. On the basis of P instructions of the control program 4a, a register address fra is designated by the PU 2, and data is written into the designated register IR(i) by the PU 2 or the data is read from the register IR(i).

Therefore, in the data processing system 10 equipped with the VU 1 shown in FIG. 2, the PU 2 sets in the register IR(7) an initial value for starting the arithmetic circuit 21, and in the register IR(0) a condition for terminating the process through the comparison with a result of circuit 21 at the comparator circuit 22. After that, by starting the sequencer 14 of the VU 1 upon the signal fv, the specified process is repeated by the circuit 21. During the execution, a result of comparison at the comparator circuit 22 is supplied to the sequencer 14. The sequencer 14 determines a next state based on the present state and a result from the comparator circuit 22, and stores the next state into the state register 15. The content of the state register 15 becomes an input for the next operation processing of the arithmetic circuit 21. Furthermore, the PU 2 is able to monitor the content of the state register 15, so that the status of execution of the VU 1 can be monitored through the PU 2.

In the data processing system 10, the PU 2 also be able to monitor data stored in the IR(i) during the execution, if the required by the program. For example, the PU 2 monitors data stored in the IR(3) using a function of the register control circuit 31. It is also possible to debug the operating of the circuit 21 and other function of the VU 1.

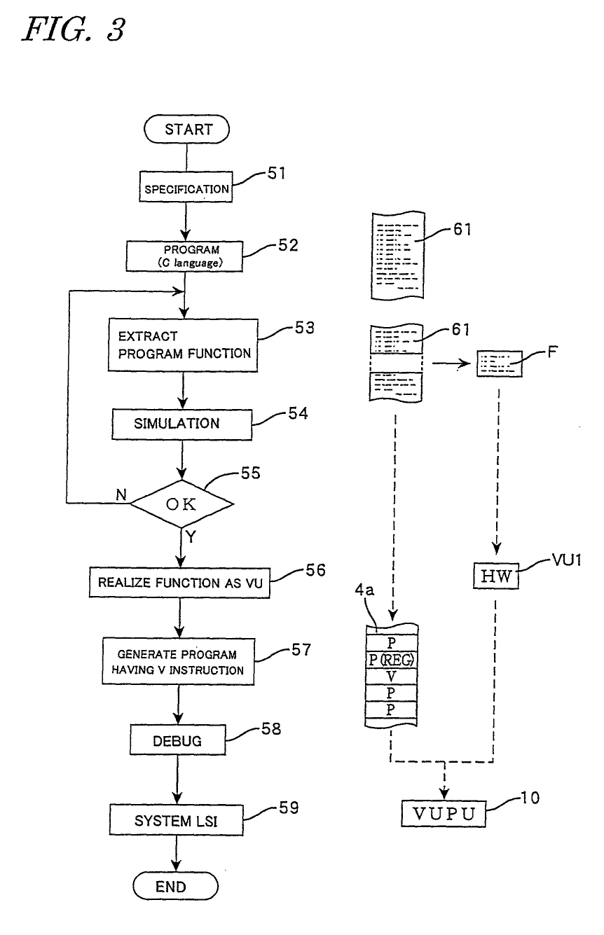

FIG. 3 illustrates a process of developing the system LSI realized as the data processing system 10, in a flowchart and a conceptual diagram. First, in step 51, the contents of processes to be performed the system LSI are given as the specifications of the system LSI. In step 52, on the basis of the specifications, a program (original program) 61 is prepared using a high-level language such as the C language or the like. If a conventional digital processor is selected for executing the program 61, the program 61 is compiled and converted into program codes executable by the digital processor.

However, in this embodiment, the original program is further treated. In step 53, a program function (hereinafter, “function”), or functions, F that is or would become bottle-neck process and that should desirably be realized and executed by hardware is extracted from the program 61. Subsequently in step 54, a simulation is performed by using an instruction set simulator (ISS) on condition that the function F be executed by hardware device VU, and the other portion of the program 61 be executed by the general purpose processor PU. It is possible to evaluate the appropriateness of the extracted function F as a function unit for realizing hardware among the functions or operations of program 61, on the basis of the proportion or rate of the processing counts, the rate of the processing time, the response time per process, etc. in the simulation.

After the evaluation, in step 55, effects such as the reduction in the processing time, the frequency of utilization of the hardware UV, etc. of the case that the extracted function F is realized as hardware VU, are confirmed. If a result of the simulation is good, a data path portion 20 capable of executing the extracted function F is designed in step 56. Furthermore, a VU 1 equipped with the data path portion 20 suitable for the processing of the aforementioned function unit F is designed and developed.

As for the program 61, in step 57, the portion of the function F realized in the VU is replaced with a special purpose instruction (V instruction) for the VU 1, and the other portion is replaced with general purpose instructions (P instructions) executable by the PU 2. Thus, the control program 4a for controlling the system LSI 10 is generated. In step 58, the system LSI 10 equipped with the VU 1 and the PU 1 is debugged based on the control program 4a. After the operation is checked in step 59, the data processing system (the system LSI) 10 is provided. The data processing system 10 of this invention is called VUPU since it is equipped with the VU 1 capable of executing the function F upon the V instruction and the PU 2 capable of executing other general processes upon P instructions. The procedure develops the VUPU 10 that is specialized to the specifications given in step 51.

The VU 1 of the data processing system 10 of this embodiment has interface registers IR(i) and the PU 2 can select and set the data in the interface registers IR(i) using the register control portion 31. Therefore, in the process of generating the control program 4a in step 57, input-output operations from the PU 2 to the desired IR(i) of the VU 1 is described by one of the P instructions, for example, ov instruction that is a register input-output instruction. The input-output operation to the registers by the register input-output instruction becomes possible to transfer the initial value for executing the function F upon the V instruction, transfer a terminal condition or an ending condition of the function F, and others. Therefore, it becomes possible to use the functions F of the VU 1 in many cases for performing the processes in the program 61.

For example, when the data processing system 10 is the system LSI for performing the program in which the function F repeatedly appears merely for different parameters, the VU 1 will be repeatedly used with the different parameters. Therefore, the data processing system 10 has both a high processing speed and small in size and being economical. The debug in step 58 also achieves the merit that the data of the registers IR(i) can be referred to via the PU 2 at any time. For example, by accessing the interface register in which the operation result is stored, from the PU 2, the progress of operation of the VU 1 can be monitored from the PU 2 using a debug program.

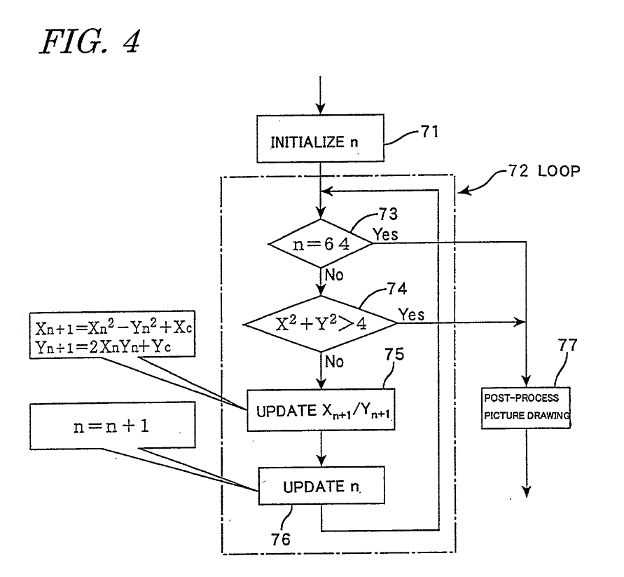

In development of a system LSI having picture drawing facilities, in order to provide the picture drawing function based on a fractal theory, the system LSI shall have a function of performing a Mandelbrot set computation or operation. This set computation has a loop process that needs a product-sum calculation with many repetitions as illustrated in FIG. 4. Therefore, the set computation is suitable extracting the special function F from the program for hardware realization. FIG. 4 shows a part of the program 61 for performing the Mandelbrot computation. First, in step 71, operation parameters, such as an initial value, a terminal condition, etc., are set, and the number of repetitions n is initialized. Then, process enters in a loop 72. In this process, the terminal conditions are checked in steps 73 and 74. Until at least one of the terminal conditions is met, computation is repeated in steps 75 and 76 to update the value and the number n of repetitions. After one of the terminal conditions in steps 73 and 74 is met, the process exits the loop 72 and enters a picture drawing process of step 77.

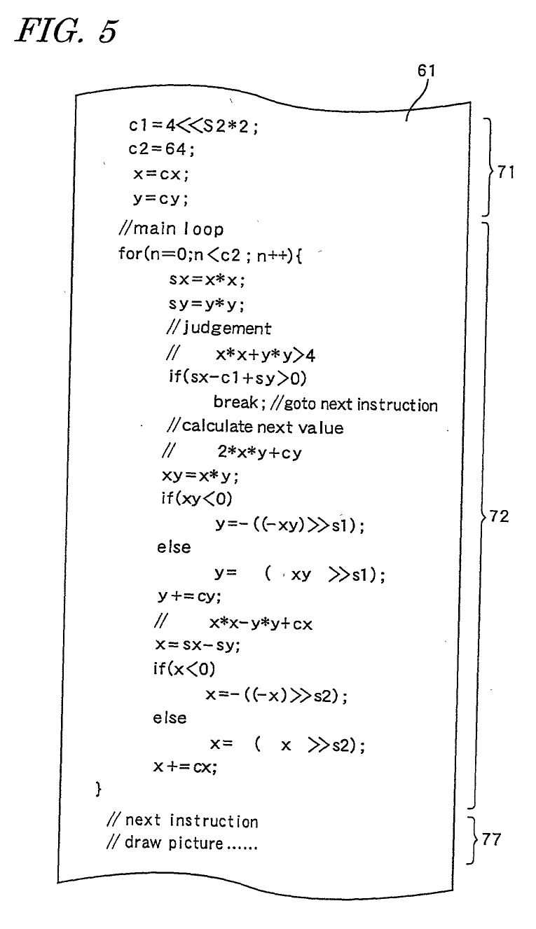

FIG. 5 shows a part of the program 61 that describes the Mandelbrot computation illustrated in FIG. 4 that is specified by the C language in the specification. This part of the program 61 is divided into a process of setting parameters at step 71, a loop process at step 72, and a post-process at step 77. It is assumed herein that the loop of step 72 is extracted as the special program function F, and is realized in the form of the special circuit for hardware processing. In FIG. 5, a variable c1 is the one of the terminal condition used in an IF sentence, and a variable c2 is the other terminal condition used in a FOR sentence. The variables c1 and c2 are set to 4 and 64, respectively. Variables x and y are initial values of the computation, and are set to cx and cy. In the calculation loop of step 72, the predetermined steps are repeatedly executed according to the initial values and the terminal conditions set in the step 71. Hence, this calculation process performed using the special circuit can be used for other parts of the program 61 as well, by changing the initial values and the terminal conditions. This description for making loop is quite typical. A different functional loop or a targeted loop is able to also extracted as a function unit for hardware processing, and the invention can also be applied in a similar procedure.

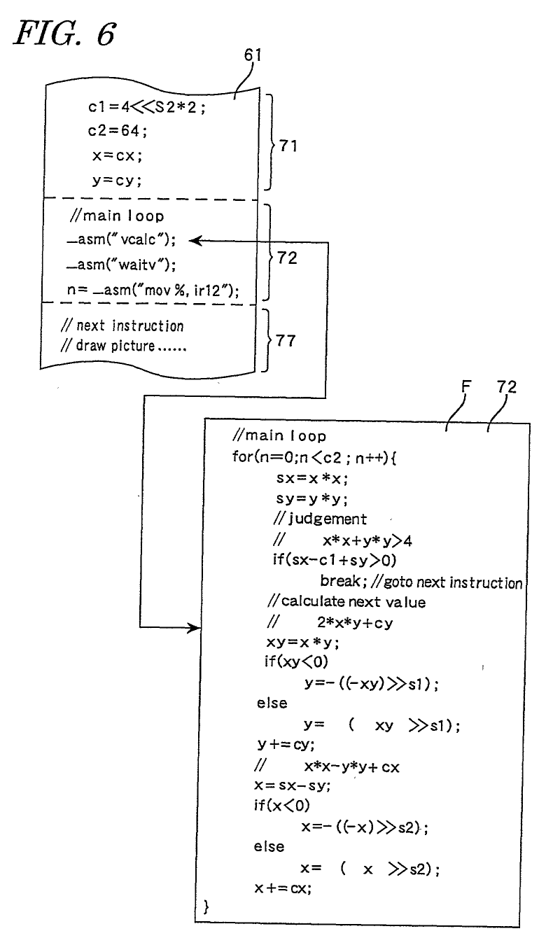

FIG. 6 shows the program where the function F is extracted. The loop of step 72 in the program 61 is described in an in-line assembler instructions, namely, the loop description of FIG. 5 is replaced with the V instruction “vcalc” to execute the function F in the special circuit VU 1. Subsequently to the V instruction, P instruction “waitv” to wait in order to synchronize the PU 2 during the execution of the V instruction in the VU 1, and another P instruction to acquire the result of function F into value from the register IR 12 of the VU 1. By the simulation ISS described above, it becomes possible to evaluate the range of the function unit F extracting for realization in the form of the VU 1, the utilization of the extracted function F, and the degree of speed increase for optimizing extracting function F for hardware processing by the VU 1.

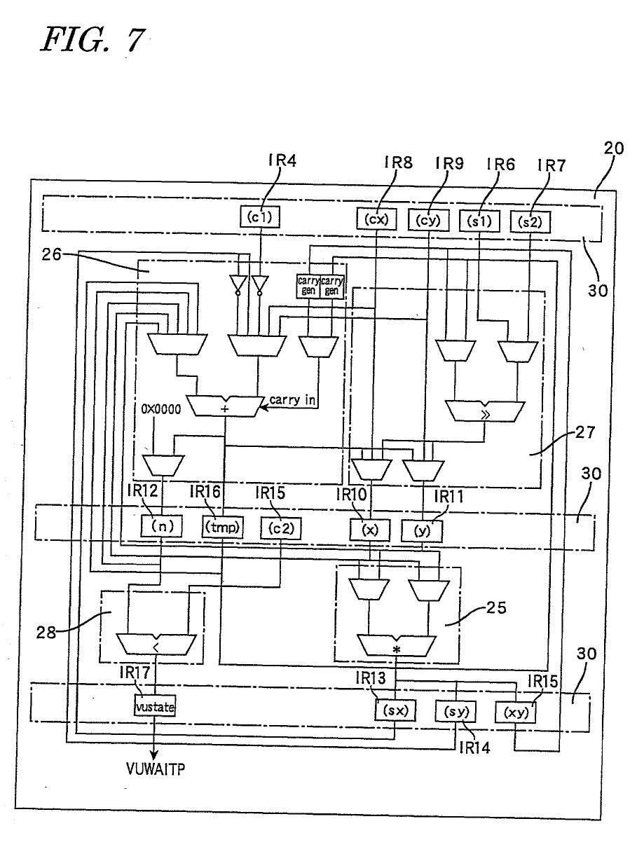

FIG. 7 schematically shows a construction of a data path portion 20 for executing the function (function unit) F shown in FIG. 6, that is the Mandelbrot computation, by hardware. The data path portion 20 has a path or processing part 25 that functions as a multiplier, a path 26 that functions as an adder, a path 27 that functions as a shifter, and a path 28 that performs judgment of terminal condition. These paths 25 to 28 are designed so as to arithmetic or performing operations related to data set in the interface registers IR(i). As mentioned above the interface registers IR(i) can be selectively accessed from the PU 2 for inputting data in the register IR(i), outputting a computation or operation result from the register IR(i), and/or comparing data set in the register IR(i). In FIG. 7, the interface registers IR(i) are shown with the specific numbers such as IR7. Although the register control circuit 31 in FIG. 2 is elimiated, the data path portion 20 has the register control circuit for selecting each interface register IRm (m is an integer) and accessing the selected IRm from the PU 2, as described with reference to FIG. 2.

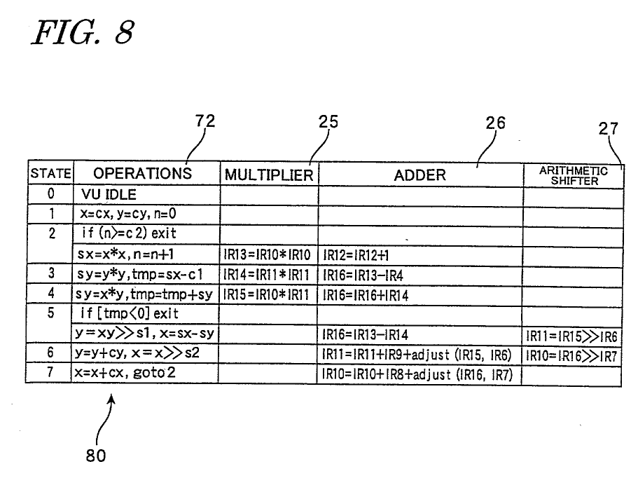

FIG. 8 shows states how the loop process 72 illustrated in FIG. 6 is controlled by the sequencer 14, which is a control portion of the VU 1 for executing the process 72 realized in the data path portion 20 shown in FIG. 7. In this embodiment, in order to execute the loop 72, a series of operations 80 shown at a left side in FIG. 8 is extracted as the function F from the source code or original program described in the C language. Then, for executing the operation process 80, the data path portion 20 is provided with the multiplier 25, the adder 26, and the arithmetic shifter 27. These paths or processing parts in the data path portion 20 that perform operations of the multiplier 25, the adder 26 and the arithmetic shifter 27 are independent from one another. Therefore, processes in each paths 25 to 27 is executed individually in parallel. Hence, the seven states, as shown in FIG. 8, are prepared in order to execute the loop process 72 suitably combining sequences of the operations 80. Therefore, the data path portion 20 controlled by the 7-step sequencer 14 performs the loop process 72 using hardware logic, and the VU 1 equipped with the data path portion 20 shown in FIG. 7 is provided for the system LSI 10.

As mentioned above, by the developing method of the data processing system 10 of this invention, a program function such as the loop process 72 can be executed for being performed by the suitable hardware of the data path portion 20 using the single V instruction with high processing speed of the special purpose circuit. Furthermore, the data path portion 20 has a plurality of the operation resources, such as the path 25 of multiplier and the other paths 26 and 27, and these operation resources are able to execute in parallel. By utilizing the parallel characteristic of these paths, number of steps for executing the function realized in the data path portion 20 is reduced or compressed on the way to producing the special purpose circuit. In this respect, the developing method of this invention has a possibility of considerable improvement in the processing speed.

In the data path portion 20 in this embodiment, the arithmetic shifter 27 performs a right shift while maintaining the sign. However, in the case of a negative number, the arithmetic shifter 27 causes the rounding toward infinite in the negative direction, thus leading to an error. Therefore, a design is made such that in the process by the adder 26 immediately following the shift, a correction value is given to a carry-in so as to ensure an operation precision.

Furthermore, the data of the register IR17 that indicate the state of the VU 1 is decoded and a vuwaitp signal having a 1-bit is set. The PU 2 senses the vuwaitp signal upon the wait instruction of the P instruction. The vuwaitp signal is set to 1 when the VU 1 is executing the vcalc instruction, which is the V instruction. In the other cases, the vuwaitp signal is set to 0. By referring the vuwaitp signal, the PU 2 and the VU 1 can proceed with the each process synchronously.

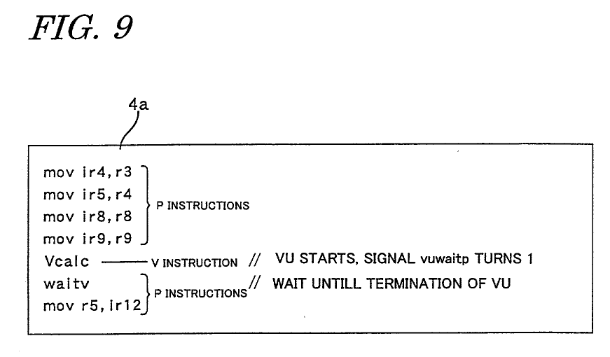

FIG. 9 shows a part of the control program 4a in which a P instruction to store a parameter R3 into the interface register IR4 that is reserved for storing the variable c1, a P instruction to store a parameter R4 into the register IR5 that is reserved for storing the variable c2, a P instruction to store an initial value R8 (cx) into the register IR8 that is reserved for storing the variable x, a P instruction to store an initial value R9 (cy) into the register IR9 that is reserved for storing the variable y, the V instruction calc to execute the process in the VU 1, the P instruction aitv to synchronize the PU 2 with the VU 1, and a P instruction to write a terminal value of the variable into the register R5 of the PU 2 from the register IR12 that is reserved for storing the variable are sequentially described by assemblers. In the program 61, shown in FIG. 5, described by the C languages based on the specification of the system LSI, the port of the loop process 72 is realized by hardware in the VU 1, and the part of descriptions for the loop process 72 is replaced by the V instruction. Therefore, the control program 4a of the system LSI 10 having the VU 1 and the PU 2 has P instructions for setting parameters and initial values so on in the interface registers, and V instructions for controlling the VU 1. By storing the control program 4a converted by a compiler into codes interpretable by the DU 3 or the FU 4, the system LSI (VUPU) 10 which is equipped with the VU 1 and the PU 2, namely the VUPU type system LSI that performs processes in accordance with required specifications is provided.

Furthermore, in this embodiment, all the registers for storing data in the data path portion 20 are the interface registers that can be selectively accessed from the PU 2 as shown in FIG. 7. Therefore, the data stored in the individual registers can be accessed from the PU 2 while the VU 1 is executing the process or processes. The control program 4a may have functions that output data stored in the interface registers to the outside of the LSI 10 by a suitable method. The program having such functions makes possible to monitor the process of the VU 1 from outside the LSI 10 and is suitable for debugging the system LSI 10 produced by the developing method of this invention.

Thus, the invention provides a data processing apparatus or system, the most preferred embodiment is a system LSI, that has a general purpose data processing unit PU capable of general processing, and a special purpose data processing unit VU capable of executing a specific data processing at high speed by hardware. In addition, the data processing system of this invention is suitable for performing an application having a process or processes with many repetitions of a calculation and the like, since an extracted function unit or units in a program for executing the application is implemented in the VU as a hardware execution means allowing higher-speed processing. Other processes of the program are executed by the PU since the PU is the general processor. Therefore, as compared with fully customized or fully specialized and dedicated system LSI, the system LSI of this invention curbs the cost increase due to adoption of hardware and the increase in the period of design and allows flexible handling of changes in specifications and changes/modifications in any stage of development.

Furthermore, in the data processing system of this invention, the data stored in the registers of the VU can be flexibly manipulated from the PU. Thus, the VU of this invention is has the special purpose and dedicated circuit that is also high versatile. Therefore, the function unit implemented in the VU hardware is very flexible controlled and used by re-writing the values and/conditions from outside the VU. Therefore, the utilization of the VU becomes so high. In addition, the contents of the registers of the VU can be monitored easily. As a result, present developing technique of system LSIs designs and develops a system LIS in which some functions of the program described in a high level language are extracted and are realized by hardware in a very short period of time under the condition that the performance of the LSI is easily verified.

The system LSI and the developing method thereof of this invention makes it possible to processing an arbitrary or any kind of function or function unit described in or a part of a program using one or a few special instructions. In addition, any conditions and parameters such as the initial, termnal etc. for executing the function and/or function unit performed by the special instructions can be set or varied at the time of, and/or during the execution, whenever necessary, through parameter setting instructions (general instructions) in the program. Therefore, the invention greatly expands the fields of application of special purpose processors. Also, the invention allows construction of system LSIs with excellent cost performance, and significantly contributes to industrial development.

In particular, in this invention, any kinds of loop sentence can be compressed into one instruction (or very few instructions), and any conditions referred in the loop can be flexibly set and changed. In this aspect, this invention is very effective in a technique for realizing software by hardware, since a loop sentence is a one of the most popular sentence in the usual program and occupies much space thereof.

When the PU sets the conditions of execution by the special purpose instruction, some kind of means for data transferring between the PU and VU is needed. In the invention, by adopting a register transfer mechanism that has a bus structure with the control being performed on the PU side.

The invention does not merely present an effective special purpose instruction constructing technique for converting a loop process into an instruction, but presents a design technique for various system LSIs that are needed and will be needed by industries. That is, from a specification desired to be realized by an LSI described in a high level language, extracting a loop sentence as a function unit and tuning it into an effective hardware instruction will make it possible to easily construct a special purpose system LSI or a special purpose processor that achieves very high speed execution at least with respect to the described content.

It is an enormous task to realize all the specifications given to a system LSI by hardware, and it is presently considered that such a task is substantially economically impracticable in terms of time of and cost. However, according to the invention, of the specifications provided for a system LSI, functions suitable for hardware realization are extracted in an appropriate unit, and only the functions confirmed by a simulation to provide an effect, such as a speed increase or the like, are realized by hardware. Therefore, the range of hardware realization is limited, so that design and development can be easily accomplished and the cost can be minimized. On the other hand, the effect of hardware realization can be maximized. Thus, the invention makes it possible to economically provide a high-performance LSI.

What is claimed is:

1. A data processing system comprising:
at least one special purpose data processing unit having a data path portion for executing specific data process by a special purpose instruction;
a general purpose data processing unit for executing processes by general purpose instructions; and
an instruction issue unit for issuing instructions to the special purpose data processing unit and the general purpose data processing unit based on a program that has the special purpose instruction and the general purpose instructions,
the data path portion of the special purpose data processing unit including:
a plurality of registers;
at least one processing part for performing at least one operation related to data stored in at least one of the registers; and
a register control part for selecting and performing input and/or output of data with respect to the registers from the general purpose data processing unit.

2. A data processing system according to claim 1, wherein the registers include a plurality of interface registers accessible by the general purpose data processing unit, and
wherein the register control part comprises: a register data bus for exchanging data between the interface registers and the general purpose data processing unit; and a decoder for identifying one of the interface registers based on a designation of the general purpose data processing unit.

3. A data processing system according to claim 2, further comprising a plurality of processing parts, and wherein one of the processing parts has a function that compares a terminal condition stored in one of the interface registers with an operation result stored in one of the registers and outputs a factor for terminating the process of the special purpose data processing unit.

4. A data processing system according to claim 2, wherein an operation result is stored in one of the interface registers.

5. A control method of a data processing system comprising: at least one special purpose data processing unit having a data path portion for executing specific data process by a special purpose instruction; a general purpose data processing unit for executing processes by general purpose instructions; and an instruction issue unit for issuing instructions to the special purpose data processing unit and the general purpose data processing unit based on a program that has the special purpose instruction and the general purpose instructions,
the data path portion of the special purpose data processing unit including a plurality of registers and a processing part for performing at least one operation related to data stored in at least one of the registers,
the control method comprising a register control step of selecting and performing input and/or output of data with respect to the registers from the general purpose data processing unit.

6. A control method according to claim 5,
wherein the registers have a plurality of interface registers that is accessible by the general purpose data processing unit, and
wherein the register control step comprises:
a step of selecting one of the interface registers from the general purpose data processing unit by a decoder for identifying one of the interface registers; and
a step of inputting and/or outputting data with respect to the interface registers selected in the step of selecting, via a register data bus for exchanging data between the interface registers and the general purpose data processing unit.

7. A control method according to claim 5, wherein in the register control step, one the registers selected stores data for comparing with an operation result stored in one of the registers to output a factor for terminating the process of the special purpose data processing unit.

8. A control method according to claim 5, wherein in the register control step, one of the registers selected stores an operation result.

9. A program comprising:
a special purpose instruction to a special purpose data processing unit having a data path portion for executing specific data process; and
general purpose instructions to a general purpose data processing unit,
wherein the data path portion performs a process related to data stored in at least one of a plurality of interface registers that are accessible from the general purpose data processing unit, and
wherein the general purpose instructions include a register input-output instruction to select and input and/or output data with respect to one of the interface registers.

10. A program according to claim 9, wherein the program has a step of setting a terminal condition of processes started by of the special purpose instruction by the register input-output instruction.

11. A program according to claim 9, wherein the program has a step of performing monitoring a state of the process in the data path portion by the register input-output instruction.

12. A method for developing a data processing system comprising:
a step of preparing an original program for executing processes based on a specification;
a step of extracting from the original program a function unit that is desirable executed by a data path portion for a specific data processing;
a step of generating the data processing system having a special purpose data processing unit that has the data path portion for the specific data processing, and a general purpose data processing unit;
a step of generating a program for controlling the data processing system by substituting the original program with a special purpose instruction to the special purpose data processing unit and general purpose instructions to the general purpose data processing unit.

13. A method according to claim 12,
wherein the data path portion performs a process related to data stored in at least one of a plurality of interface registers that are accessible from the general purpose data processing unit, and
wherein in the step of generating the program, data related to the function unit are manipulated by a register input-output instruction of the general purpose instructions, the input-output instruction selects and inputs and/or outputs data with respect to one of the interface registers.

14. A method according to claim 13, wherein in the step of generating the program, a process of setting a terminal condition of the function unit is described using the register input-output instruction.

15. A method according to claim 13, wherein in the step of generating the program, a process of monitoring a state of process of the data path portion is described using the register input-output instruction.
